(19) United States
(12) Patent Application Publication
(10) Pub. No.: US 2025/0256294 A1
(43) Pub. Date: Aug. 14, 2025

(54) SPRAY BOTTLE

(71) Applicant: CHONGQING TIANYU ELECTRONIC COMMERCE CO., LTD., Nan'an District, Chongqing (CN)

(72) Inventor: Caitian ZHAO, Yuzhong District, Chongqing (CN)

(73) Assignee: CHONGQING TIANYU ELECTRONIC COMMERCE CO., LTD., Nan'an District, Chongqing (CN)

(21) Appl. No.: 18/704,794

(22) PCT Filed: Mar. 30, 2022
(86) PCT No.: PCT/CN2022/084050

§ 371 Date: Apr. 25, 2024

(30) Foreign Application Priority Data
Nov. 2, 2021 (CN) 202122660500.6

(51) Int. Cl. B05B 11/00; A01M 29/12

(52) U.S. Cl. CPC B05B 11/0038; A01M 29/12; A01M 2200/012

(57) ABSTRACT

A spray bottle includes a housing, an inner bottle (3) and a spray nozzle (4). An opening (5) is provided in a side face of the housing, and a flip cover (6) is arranged at the opening (5); and an inner box (7) is arranged inside the opening (5), and one side of the inner box (7) is provided with a mouth (8) corresponding to the opening (5).

### TECHNICAL FIELD

The present disclosure relates to the technical field of bottles, and in particular to a spray bottle.

### BACKGROUND

In household and outdoor activities, people often use mosquito repellent to prevent mosquito bites. Mosquito repellent is mostly contained in a spray bottle to facilitate spraying at any time. However, the existing bottle for mosquito repellent is single in function and inconvenient to use.

### SUMMARY

An objective of the present disclosure is to provide a spray bottle, which is convenient to use.

In order to achieve the objective above, the following technical solution is provided:

A spray bottle includes a housing, an inner bottle, and a spray nozzle, wherein an opening is formed in a side face of the housing, and a flip cover is arranged at the opening; an inner box is arranged inside the opening, and one side of the inner box is provided with a mouth corresponding to the opening.

Preferably, one side, away from the opening, of an outer edge of the inner box is provided with a flange, and a size of an outer circumference of the flange is greater than a size of an outer circumference of the opening.

Preferably, one side of the inner bottle is provided with a groove in fit with a shape of a back of the inner box, and the back of the inner box is mounted in the groove.

Preferably, an edge of the mouth of the inner box is provided with a first clamping strip, and an inner side of the flip cover is provided with a second clamping strip in snap fit with the first clamping strip.

Preferably, one end of the flip cover is hinged with the housing, and the other end of the flip cover is provided with a buckle groove.

The operation principle and use principle of the present disclosure are as follows: an inner bottle provided with a spray nozzle is placed inside the housing. By forming an opening in an outer side of the housing, at the opening, an inner box is arranged between the inner bottle and the housing, which is used for placing other articles, such as cooling ointment and mosquito repellent cream.

The present disclosure has the beneficial technical effects as follows: 1. The spray bottle is additionally provided with the inner box to facilitate the storage of other small articles. 2. The design of the housing of the spray bottle is beneficial for preventing the spray nozzle from being triggered accidently, and the spray bottle is convenient to take and carry.

### BRIEF DESCRIPTION OF THE DRAWINGS

FIG. 1 is a schematic diagram of an overall structure of a spray bottle according to the present disclosure;

FIG. 2 is a schematic diagram of an exploded view of a spray bottle according to the present disclosure;

FIG. 3 is a structural schematic diagram of an inner box in a spray bottle according to the present disclosure;

FIG. 4 is a structural schematic diagram of a flip cover in a spray bottle according to the present disclosure.

In the drawings: 1 left housing; 2 right housing; 3 inner bottle; 4 spray nozzle; 5 opening; 6 flip cover; 7 inner box; 8 mouth; 9 flange; 10 groove; 11 first clamping strip; 12 second clamping strip; 13 buckle groove; 14 clamping groove; 15 hook; 16 lifting handle.

### DETAILED DESCRIPTION OF THE EMBODIMENTS

The spray bottle of the present disclosure is further described below with reference to the accompanying drawings and specific embodiments.

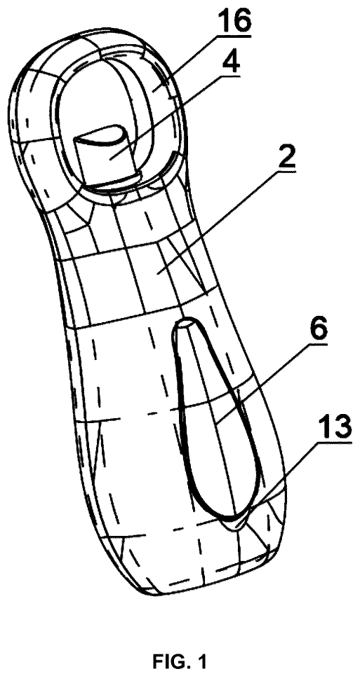

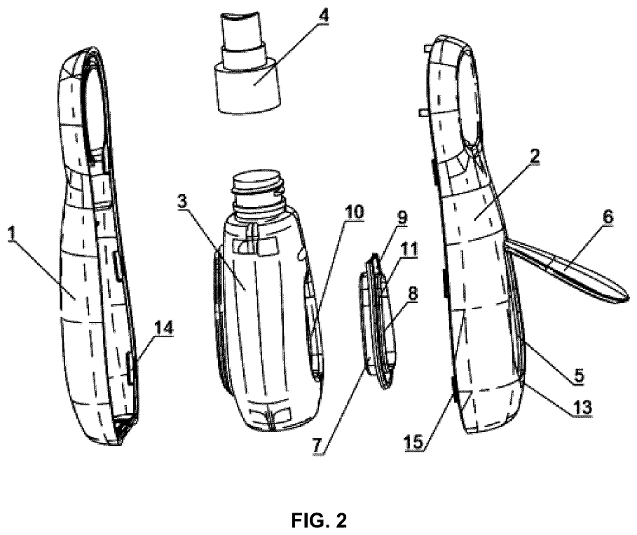

As shown in FIG. 1 and FIG. 2, a spray bottle includes a housing, an inner bottle 3, and a spray nozzle 4. An opening 5 is formed in a side face of the housing, and a flip cover 6 is arranged at the opening 5. An inner box 7 is arranged inside the opening 5, and one side of the inner box 7 is provided with a mouth 8 corresponding to the opening 5.

The inner bottle 3 provided with the spray nozzle 4 is placed inside the housing, and the spray nozzle 4 extends into the inner bottle 3 through a connecting pipe. According to this solution, the opening 5 is formed in an outer side of the housing, and at the opening 5, the inner box 7 is arranged between the inner bottle 3 and the housing, and is configured for placing and storing other small articles, such as cooling ointment and mosquito repellent cream. The inner box 7 and the housing may be fixedly connected, may be integrally connected, or may directly abut against an outer side of the inner bottle 3 in the opening 5, as long as the flip cover 6 can be closed.

Further, as shown in FIG. 2, the housing includes a left housing 1 and a right housing 2, which are clamped by a buckle. An upper part of each of the left housing 1 and the right housing 2 is provided with a notch for accommodating the spray nozzle 4. The notches on the left housing 1 and the right housing 2, after being spliced, are in fit with an outer diameter of the spray nozzle 4. An edge of an inner side of the left housing 1 is provided with a clamping groove 14, an edge of an inner side of the right housing 2 is provided with a hook 15 in fit with the clamping groove 14, and the left housing 1 is buckled with the clamping groove 14 of the right housing 2 through the hook 15. During mounting, the inner bottle 3 is placed between the left housing 1 and the right housing 2, then the left housing 1 and the right housing 2 are buckled together, and thus the inner bottle 3 can be mounted inside the housing.

Further, as shown in FIG. 1 and FIG. 2, the upper part of each of the left housing 1 and the right housing 2 is further provided with an integrally formed lifting handle 16. In this embodiment, the lifting handle is circular, and the spray nozzle 4 extends into the lifting handle through the notches at the tops of the left housing 1 and the right housing 2. During use, index finger of a user enters the lifting handle and presses the spray nozzle 4 to spray the liquid in the inner bottle 3. The circular lifting handle is not only convenient for the user to carry and take, but also can prevent the liquid from leaking due to accidental pressing of the spray nozzle 4 on the spray bottle.

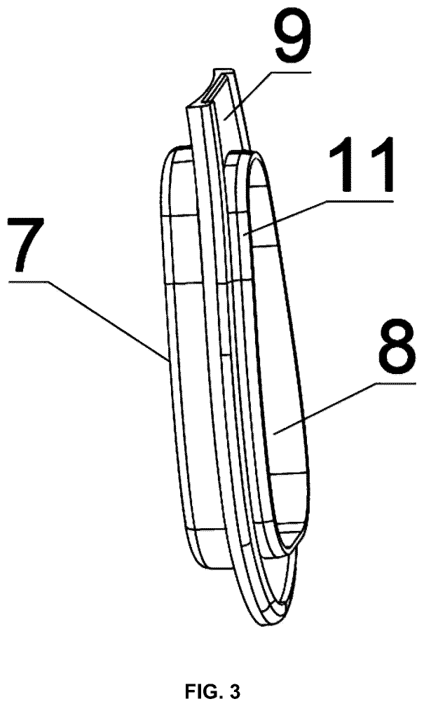

Further, as shown in FIG. 3, one side, away from the opening 5, of an outer edge of the inner box 7 is provided with a flange 9, and a size of an outer circumference of the flange 9 is greater than a size of an outer circumference of the opening 5. In this embodiment, the inner box 7 is placed between the inner bottle 3 and the right housing 2, and the back of the inner box 7 is limited by the inner bottle 3, and the flange 9 prevents the inner box 7 from falling from the opening 5.

Further, one side of the inner bottle 3 is provided with a groove 10 in fit with the shape of the back of the inner box 7, and the back of the inner box 7 is mounted in the groove 10. In this embodiment, the back of the inner box 7 is mounted in the groove 10 at the outer side of the inner bottle 3, thus preventing the inner box from falling from the opening 5. Meanwhile, the inner box can be more stably mounted between the housing and the inner bottle 3 with the flange 9. That is, the back of the inner box 7 is mounted in the groove 10 at the outer side of the inner bottle 3, and the flange 9 abuts against the inner side of the opening 5 of the housing.

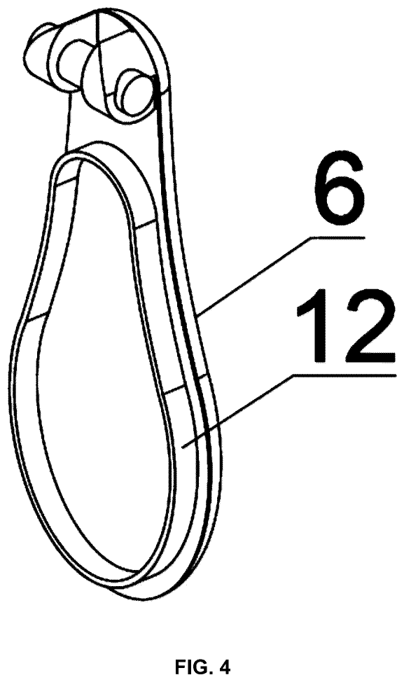

Further, as shown in FIG. 3 and FIG. 4, an edge of the mouth 8 of the inner box 7 is provided with a first clamping strip 11, and an inner side of the flip cover 6 is provided with a second clamping strip 12 in snap fit with the first clamping strip 11. The first clamping strip 11 is clamped on the outer side or inner side of the second clamping strip 12, so as to close the flip cover 6. The inner box 7 can be opened by separating the first clamping strip 11 and the second clamping strip 12. In this embodiment, the first clamping strip 11 and the inner box 7 are integrally formed, and the second clamping strip 12 and the flip cover 6 are integrally formed.

Further, as shown in FIG. 1 and FIG. 2, one end of the flip cover 6 is hinged with the housing, and a buckle groove 13 is formed between the other end of the flip cover 6 and the opening 5. In this embodiment, at the opening 5, the flip cover 6 is hinged to the right housing 2 through a connecting rod, so as to be rotatably connected to the right housing 2. The buckle groove 13 is arranged on the right housing 2, that is, a bottom end of the opening of the right housing 2 is provided with a recess. When the flip cover 6 is opened, the flip cover 6 can be opened by inserting a finger nail into the buckle groove 13. In other embodiments, the buckle groove 13 may also be provided on the flip cover 6. The flip cover 6 may also be connected to the housing through flexible plastic to facilitate folding, and the flexible plastic is integrally connected to the flip cover 6 and the housing.

1. A spray bottle, comprising a housing, an inner bottle (3), and a spray nozzle (4), wherein an opening (5) is formed in a side face of the housing, and a flip cover (6) is arranged at the opening (5); an inner box (7) is arranged inside the opening (5), and one side of the inner box (7) is provided with a mouth (8) corresponding to the opening (5).

2. The spray bottle according to claim 1, wherein one side, away from the opening (5), of an outer edge of the inner box (7) is provided with a flange (9), and a size of an outer circumference of the flange (9) is greater than a size of an outer circumference of the opening (5).

3. The spray bottle according to claim 1, wherein one side of the inner bottle (3) is provided with a groove (10) in fit with a shape of a back of the inner box (7), and the back of the inner box (7) is mounted in the groove (10).

4. The spray bottle according to claim 1, wherein an edge of the mouth (8) of the inner box (7) is provided with a first clamping strip (11), and an inner side of the flip cover (6) is provided with a second clamping strip (12) in snap fit with the first clamping strip (11).

5. The spray bottle according to claim 3, wherein an edge of the mouth (8) of the inner box (7) is provided with a first clamping strip (11), and an inner side of the flip cover (6) is provided with a second clamping strip (12) in snap fit with the first clamping strip (11).

6. The spray bottle according to claim 1, wherein one end of the flip cover (6) is hinged with the housing, and a buckle groove (13) is arranged between an other end of the flip cover (6) and the opening (5).

7. The spray bottle according to claim 3, wherein one end of the flip cover (6) is hinged with the housing, and a buckle groove (13) is arranged between an other end of the flip cover (6) and the opening (5).

8. The spray bottle according to claim 4, wherein one end of the flip cover (6) is hinged with the housing, and a buckle groove (13) is arranged between an other end of the flip cover (6) and the opening (5).

9. The spray bottle according to claim 2, wherein one side of the inner bottle (3) is provided with a groove (10) in fit with a shape of a back of the inner box (7), and the back of the inner box (7) is mounted in the groove (10).

10. The spray bottle according to claim 9, wherein an edge of the mouth (8) of the inner box (7) is provided with a first clamping strip (11), and an inner side of the flip cover (6) is provided with a second clamping strip (12) in snap fit with the first clamping strip (11).

11. The spray bottle according to claim 9, wherein one end of the flip cover (6) is hinged with the housing, and a buckle groove (13) is arranged between an other end of the flip cover (6) and the opening (5).

12. The spray bottle according to claim 2 wherein an edge of the mouth (8) of the inner box (7) is provided with a first clamping strip (11), and an inner side of the flip cover (6) is provided with a second clamping strip (12) in snap fit with the first clamping strip (11).

13. The spray bottle according to claim 12, wherein one end of the flip cover (6) is hinged with the housing, and a buckle groove (13) is arranged between an other end of the flip cover (6) and the opening (5).

14. The spray bottle according to claim 2, wherein one end of the flip cover (6) is hinged with the housing, and a buckle groove (13) is arranged between an other end of the flip cover (6) and the opening (5).

15. The spray bottle according to claim 5, wherein one end of the flip cover (6) is hinged with the housing, and a buckle groove (13) is arranged between an other end of the flip cover (6) and the opening (5).

16. The spray bottle according to claim 10, wherein one end of the flip cover (6) is hinged with the housing, and a buckle groove (13) is arranged between an other end of the flip cover (6) and the opening (5).
